(19) United States
(12) Patent Application Publication
(10) Pub. No.: US 2023/0071843 A1
(43) Pub. Date: Mar. 9, 2023

(54) FUEL ASSEMBLY AND CORE OF FAST REACTOR

(71) Applicant: Hitachi-GE Nuclear Energy, Ltd., Hitachi-shi (JP)

(72) Inventors: Kouji FUJIMURA, Tokyo (JP); Junichi MIWA, Tokyo (JP)

(73) Assignee: Hitachi-GE Nuclear Energy, Ltd., Hitachi-shi (JP)

(21) Appl. No.: 17/830,655

(22) Filed: Jun. 2, 2022

(30) Foreign Application Priority Data
Jun. 3, 2021 (JP) 2021-093475

(51) Int. Cl. G21C 1/02; G21C 3/32; G21C 3/60

(52) U.S. Cl. CPC G21C 1/022; G21C 3/3206; G21C 3/60

(57) ABSTRACT

To provide is a fuel assembly capable of easily adjusting average MA enrichment in an inner blanket region. An inner core fuel assembly 7 loaded in an inner core region 2 of a core of a fast reactor includes a plurality of fuel rods 10 and a plurality of fuel rods 19. Each of the fuel rods 10 includes a lower core fuel region 12, an inner blanket region 11, and an upper core fuel region 13. A U—Pu—Zr metal fuel is disposed in the lower core fuel region 12 and the upper core fuel region 13, and a U—Zr metal fuel is disposed in the inner blanket region 11. Each of the fuel rods 19 includes a lower core fuel region 12, an inner blanket region 20, and an upper core fuel region 13. A U—Pu—Zr metal fuel is disposed in the lower core fuel region 12 and the upper core fuel region 13 of the fuel rod 19, and a MA-Zr metal fuel is disposed in the inner blanket region 20. By adjusting the number of the fuel rods 10 and the number of the fuel rods 19, MA enrichment in the inner blanket region 9 of the fuel assembly 7 can be easily adjusted.

### CLAIM OF PRIORITY

The present application claims priority from Japanese Patent application serial No. 2021-093475, filed on Jun. 3, 2021, the content of which is hereby incorporated by reference into this application.

### TECHNICAL FIELD

The present invention relates to a fuel assembly and a core of a fast reactor, and in particular, to a fuel assembly using a metal fuel and a core in which the fuel assembly is loaded and which improves safety by avoiding core disruptive at the time of assumption of an event of accidentally withdrawal of a control rod in a fast reactor.

### BACKGROUND ART

In general, in a fast breeder reactor, a core is disposed in a reactor vessel, and the reactor vessel is filled with liquid sodium which is a coolant. The fuel assembly loaded in the core includes a plurality of fuel rods in which depleted uranium (U-238) enriched in plutonium is enclosed, a wrapper tube surrounding the plurality of bundled fuel rods, an entrance nozzle supporting lower ends of the fuel rods and a neutron shielding body located below the fuel rods, and a coolant outflow portion located above the fuel rods.

The core of the fast breeder reactor includes a core fuel region including an inner core region and an outer core region surrounding the inner core region, a blanket fuel region surrounding the core fuel region, and a shielding body region surrounding the blanket fuel region. In a case of a standard homogeneous core, Pu enrichment of the fuel assembly loaded in the outer core region is higher than Pu enrichment of the fuel assembly loaded in the inner core region. As a result, power distribution in a radial direction of the core is flattened.

Examples of a form of a nuclear fuel material contained in each fuel rod of the fuel assembly include a metal fuel, a nitride fuel, and an oxide fuel. Among these, the oxide fuel is widely used.

A mixed oxide (MOX) fuel obtained by mixing oxides of Pu and depleted uranium, that is, a pellet of the MOX fuel is filled in the fuel rods at a height of about 80 cm to 100 cm in a central portion in an axial direction. Further, in the fuel rod, axial blanket regions filled with a plurality of uranium dioxide pellets made of depleted uranium are disposed above and below the region filled with the MOX fuel, respectively. As described above, an inner core fuel assembly loaded in the inner core region and an outer core fuel assembly loaded in the outer core region include a plurality of fuel rods filled with a plurality of pellets of the MOX fuel. Pu enrichment of the outer core fuel assembly is higher than that of the inner core fuel assembly.

A blanket fuel assembly including a plurality of fuel rods filled with a plurality of uranium dioxide pellets made of depleted uranium is loaded in the blanket fuel region surrounding the core fuel region. Among neutrons generated by the nuclear fission reaction occurring in the fuel assemblies loaded in the core fuel region, neutrons leaking from the core fuel region are absorbed by U-238 in the fuel rods of the blanket fuel assembly that is loaded in the blanket fuel region. As a result, Pu-239, which is a fissile nuclide, is newly generated in the fuel rods of the blanket fuel assembly.

In addition, a control rod is used during startup and shutdown of the fast breeder reactor, and power adjustment of the nuclear reactor. The control rod includes a plurality of neutron absorber rods in which boron carbide (B₄C) pellets are sealed in a cladding tube made of stainless steel, and the neutron absorber rods are housed in a wrapper tube having a regular hexagonal cross section, similarly to the inner core fuel assembly and the outer core fuel assembly. The control rod has a configuration of two independent systems of a primary control rod system and a backup core rod system, and emergency shutdown of the fast breeder reactor can be performed by any one of the primary control rod system and the backup core rod system.

In general, a burnup reaction in the fast reactor is about 3% Δk/kk′, and assuming an accident (UTOP: Unprotected Transient Over Power) of accidentally withdrawal of the control rod with scram, a power density in the vicinity of the control rod may change, and a linear heat rate may exceed a design allowable value. If such an increase in the linear heat rate at the time of UTOP can be avoided, an increase in thermal margin and thus an improvement in the safety of the core can be implemented. In order to avoid an increase in the linear heat rate at the time of UTOP, it is effective to reduce burnup reactivity and to reduce control reactivity required for one control rod for burnup compensation.

PTL 1 describes a fuel assembly used in a fast reactor. The fuel assembly includes a plurality of fuel rods filled with a mixed oxide (MOX) fuel containing TRU (Np, Pu, Am, Cm, and the like).

PTL 2 describes a core of a fast reactor including an inner core region and an outer core region surrounding the inner core region. In the core, an inner blanket region is disposed in the inner core region. In the inner blanket region, an oxide fuel containing a depleted uranium fuel oxide containing minor actinide (MA) is present. Since the oxide fuel containing the depleted uranium fuel oxide containing MA such as Np, Am and Cm is present in the inner blanket region, void reactivity can be reduced, the burnup reactivity can be reduced, the reactivity applied to the core at the time of UTOP can be reduced, and the safety can be improved. In PTL 2, an MA content in the inner blanket region is a value within a range of 35 wt % to 45 wt %.

### CITATION LIST

### Patent Literature

PTL 1: JP-A-H05-52981

PTL 2: JP-A-2018-71997

### SUMMARY OF INVENTION

### Technical Problem

In the inner blanket region of the core of the fast reactor described in PTL 2, the oxide fuel containing the depleted uranium fuel oxide containing minor actinide is present. Minor actinide recovered from the spent fuel by reprocessing of the spent fuel is used. It is desired that minor actinide enrichment in the inner blanket region can be easily adjusted. In particular, when a metal fuel is used as a nuclear fuel material, among minor actinides, americium and curium, cannot form, a homogeneous alloy with uranium. In a case of using such a metal fuel, it is desired that average minor actinide enrichment in the inner blanket region can be easily adjusted.

An object of the invention is to provide a fuel assembly and a core of a fast reactor capable of easily adjusting the average minor actinide enrichment in the inner blanket region.

### Solution to Problem

In a fuel assembly of the invention for achieving the above object, a nuclear fuel material region in which a nuclear fuel material is present is formed, and a first lower core fuel region, a first inner blanket region, and a first upper core fuel region are formed in the nuclear fuel material region in this order from a lower end to an upper end of the nuclear fuel material region. The fuel assembly includes a plurality of first fuel rods in which the nuclear fuel material is present, and a plurality of second fuel rods in which the nuclear fuel material is present. In each of the first fuel rods, a second lower core fuel region is formed at a position corresponding to the first lower core fuel region, a second inner blanket region is formed at a position corresponding to the first inner blanket region, and a second upper core fuel region is formed at a position corresponding to the first upper core fuel region. In each of the second fuel rods, a third lower core fuel region is formed at a position corresponding to the first lower core fuel region, a third inner blanket region is formed at a position corresponding to the first inner blanket region, and a third upper core fuel region is formed at a position corresponding to the first upper core fuel region. The nuclear fuel material present in the second inner blanket region of the first fuel rod does not contain minor actinide and contains uranium, and the nuclear fuel material present in the third inner blanket region of the second fuel rod does not contain uranium and contains minor actinide.

In the fuel assembly having the above features, average enrichment of minor actinide in the first inner blanket region of the fuel assembly can be easily adjusted by ad rusting the number of the first fuel rod and the number of the second fuel rod in the fuel assembly.

It is desired that the average enrichment of minor actinide in the first inner blanket region of the fuel assembly at burnup of 0 GWdt is set to enrichment within a range of 3.7 wt % or more and 12.5 wt % or less.

By setting the average enrichment of minor actinide in the first inner blanket region to enrichment within the range of 3.7 wt % or more and 12.5 wt % or less, even when an accident of accidentally withdrawal of the control rod with scram occurs, an increase in the linear heat rate of the fuel assembly in the vicinity of the control rod is small, integrity of the fuel rod in the fuel assembly is maintained, and safety of the core is improved.

In addition, a core of a fast reactor for achieving the above object includes an inner core region in which a plurality of first fuel assemblies are loaded, and an outer core region which surrounds the inner core region and in which a plurality of second fuel assemblies are loaded. A fourth lower core fuel region, a fourth inner blanket region, and a fourth upper core fuel region are formed in the inner core region in this order from a lower end to an upper end of the inner core region. The first fuel assembly is a fuel assembly having the above features. The fourth lower core fuel region is formed at a position corresponding to the second lower core fuel region, the fourth inner blanket region is formed at a position corresponding to the second inner blanket region, and the fourth upper core fuel region is formed at a position corresponding to the second upper core fuel region.

### Advantageous Effect

According to the invention, it is possible to easily adjust the average minor actinide enrichment in the inner blanket region of the fuel assembly at burnup of 0 GWdt.

### BRIEF DESCRIPTION OF DRAWINGS

FIG. 1 is a longitudinal sectional view of a core of a fast reactor according to a first embodiment, which is a preferred embodiment of the invention.

FIG. 2 is a cross-sectional view of an inner core fuel assembly at burnup of 0 GWdt loaded in an inner core region of the core shown in FIG. 1, taken along line II-II in FIG. 1.

FIG. 3 is a cross-sectional view of the inner core fuel assembly at burnup of 0 GWdt loaded in the inner core region of the core shown in FIG. 1, taken along line in FIG. 1.

FIG. 4 is a longitudinal sectional view of the inner core fuel assembly at burnup of 0 GWdt shown in FIG. 1.

FIG. 5 is a longitudinal sectional view of an outer core fuel assembly at burnup of 0 GWdt shown in FIG. 1.

FIG. 6 is a ½ cross-sectional view of the core of the fast reactor shown in FIG. 1.

FIG. 7 is a characteristic diagram showing dependence of burnup reactivity on an average value of MA enrichment in an inner blanket region of the inner core region of the core of the fast reactor.

FIG. 8 is a longitudinal sectional view of an inner core fuel assembly at burnup of 0 GWdt loaded in an inner core region of a core of a fast reactor according to a second embodiment, which is another preferred embodiment of the invention.

FIG. 9 is a ½ longitudinal sectional view of a core of a fast reactor according to a third embodiment, which is another preferred embodiment of the invention.

FIG. 10 is a longitudinal sectional view of an inner core fuel assembly at burnup of 0 GWdt loaded in an inner core region of the core shown in FIG. 9.

FIG. 11 is a longitudinal sectional view of an outer core fuel assembly at burnup of 0 GWdt loaded in an outer core region of the core shown in FIG. 9.

FIG. 12 is a longitudinal sectional view of an inner core fuel assembly at burnup of 0 GWdt loaded in an inner core region of a core of a fast reactor according to a fourth embodiment, which is another preferred embodiment of the invention.

FIG. 13 is a longitudinal sectional view of an outer core fuel assembly at burnup of 0 GWdt loaded in an outer core region of the core of the fast reactor according to the fourth embodiment.

### DESCRIPTION OF EMBODIMENTS

Embodiments of the invention will be described below.

### First Embodiment

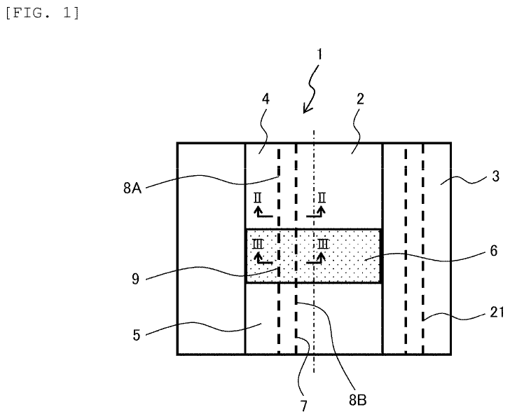

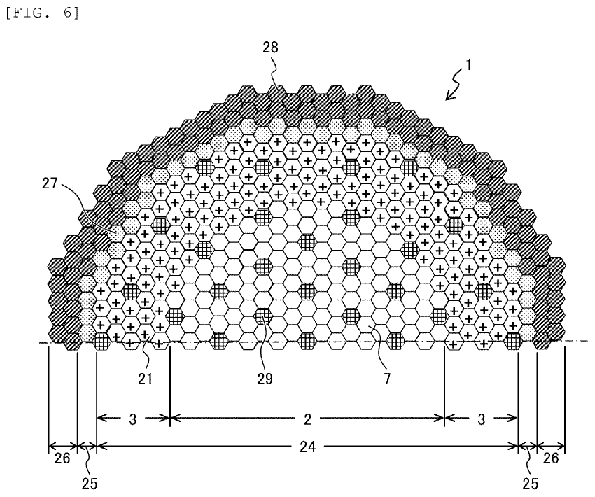

A core of a fast reactor according to a first embodiment, which is a preferred embodiment of the invention, will be described with reference to FIGS. 1 to 6.

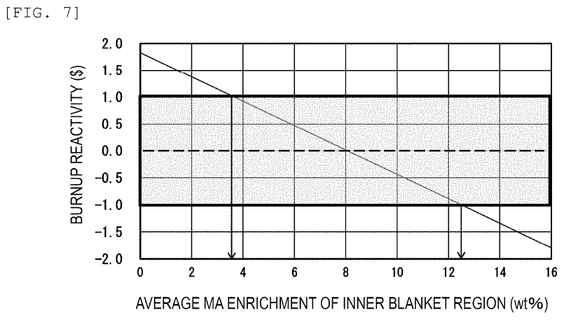

As shown in FIGS. 1 and 6, in a core 1 of the fast reactor according to the present embodiment, an inner core region 2 is disposed at a center of the core 1, and the core 1 further includes an outer core region 3 surrounding the inner core region 2, a radial blanket region 25 surrounding the outer core region 3, and a reflector region 26 surrounding the radial blanket region 25. A plurality of inner core fuel assemblies 7 are loaded in the inner core region 2, and a plurality of outer core fuel assemblies 21 are loaded in the outer core region 3. A plurality of blanket fuel assemblies 27 are loaded in the radial blanket region 25, and a plurality of neutron reflectors 28 are loaded in the reflector region 26. The core 1 is an axial non-homogeneous core in which an inner blanket region 6 is formed in the inner core region 2. In addition to the inner blanket region 6, the inner core region 2 includes an upper core fuel region 4 located above the inner blanket region 6 and a lower core fuel region 5 located below the inner blanket region 6.

A plurality of control rod assemblies 29 are disposed in the inner core region 2 and the outer core region 3, and are inserted between the inner core fuel assemblies 7 and between the outer core fuel assemblies 21. Each of the plurality of control rod assemblies 29 includes a control rod of two independent systems including a primary control rod (an adjustment rod) and a backup control rod (a safety rod). The primary control rod is used to adjust a change in reactivity and a power distribution associated with burnup of a nuclear fuel material. The backup control rod is provided for backup when the primary control rod fails. Emergency shutdown of the fast reactor can be executed by any of the primary control rod and the backup control rod.

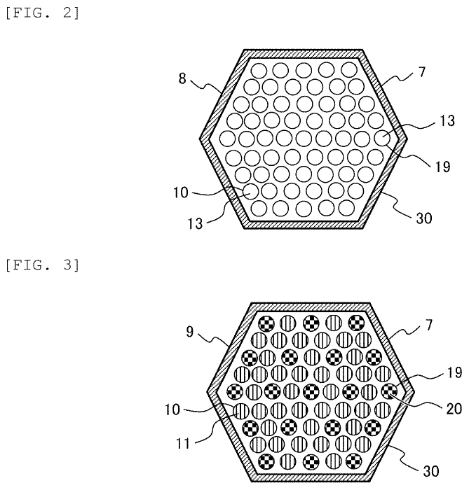

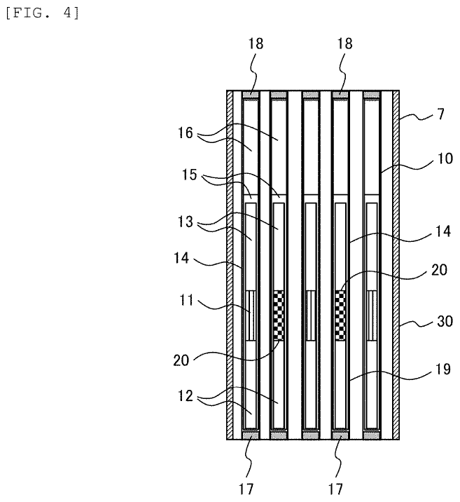

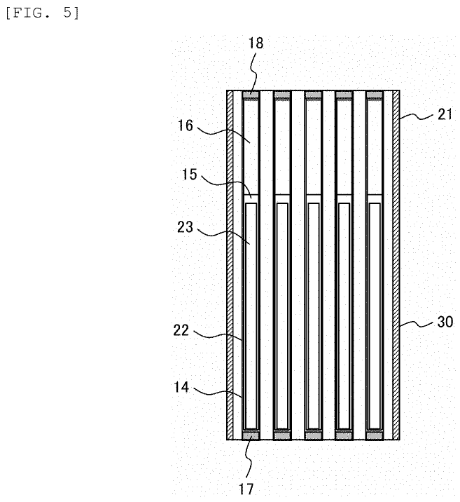

Each of the inner core fuel assemblies 7 includes a plurality of fuel rods 10 and a plurality of fuel rods 19 (see FIG. 4). A wire spacer (not shown) is wound around an outer surface of each of the fuel rods 10 and the fuel rods 19, and the fuel rods 10 and the fuel rods 19a are disposed in a wrapper tube 30 made of stainless steel which is a cylindrical structure having a regular hexagonal cross section. By the wire spacer, a coolant passage in which liquid sodium which is a coolant rises is formed between adjacent fuel rods. Each of the fuel rods 10 and the fuel rods 19 is disposed in an equilateral triangular grid in the wrapper tube 30 (see FIGS. 2 and 3), and lower ends of the fuel rods are supported by an entrance nozzle (not shown) attached to a lower end of the wrapper tube 30. A gap of a predetermined width is formed between adjacent fuel rods by the wound wire spacer. This gap serves as the coolant passage through which a liquid metal which is the coolant flows.

Each of the fuel rods 10 and the fuel rods 19 has a sealed cladding tube 14 made of stainless steel whose lower end is closed by a lower end plug 17 and whose upper end is closed by an upper end plug 18. A metal fuel material is disposed in the cladding tube 14. In the fuel rod 10, a U—Pu—Zr metal fuel and a U—Zr metal fuel are used as the metal fuel material. In the cladding tube 14 of the fuel rod 10, a lower core fuel region 12, an inner blanket region 11, and an upper core fuel region 13 are disposed upward from the lower end plug 17 of the cladding tube 14. The U—Pu—Zr metal fuel is disposed in the lower core fuel region 12 and the upper core fuel region 13. The U—Zr metal fuel which does not contain minor actinide (MA) is disposed in the inner blanket region 11. Positions of the lower core fuel region 12, the inner blanket region 11, and the upper core fuel region 13 in the fuel rod 10 coincide with positions of the lower core fuel region 5, the inner blanket region 6, and the upper core fuel region 4 in the inner core region 2, respectively.

In the fuel rod 19, the lower core fuel region 12, the inner blanket region 20, and the upper core fuel region 13 are disposed upward from the lower end plug 17 in the cladding tube 14 which is sealed by the lower end plug 17 and the upper end plug 18. The U—Pu—Zr metal fuel is disposed in the lower core fuel region 12 and the upper core fuel region 13 as in the fuel rod 10. A MA-Zr metal fuel is disposed in the inner blanket region 20. Positions of the lower core fuel region 12, the inner blanket region 20, and the upper core fuel region 13 in the fuel rod 19 coincide with the positions of the lower core fuel region 5, the inner blanket region 6, and the upper core fuel region 4 in the inner core region 2, respectively.

The U—Pu—Zr metal fuel, the U—Zr metal fuel, and the MA-Zr metal fuel described above have a solid columnar shape.

As shown in FIG. 3, in a cross section of the inner core fuel assembly 7, the plurality of fuel rods 10 and the plurality of fuel rods 19 are disposed in a manner of mixing in each other, specifically, the plurality of fuel rods 10 and the plurality of fuel rods 19 are disposed such that the fuel rods 10 are present and mixed between the fuel rods 19.

The inner core fuel assembly 7 includes a lower core fuel region 8B, an inner blanket region 9, and an upper core fuel region 8A corresponding to the lower core fuel region 5, the inner blanket region 6, and the upper core fuel region 4 of the inner core region 2 (see FIG. 1). In the inner core fuel assembly 7, the lower core fuel region 8B corresponds to the lower core fuel region 12 of each of the fuel rods 10 and 19, the inner blanket region 9 corresponds to the inner blanket region 11 of the fuel rod 10 and the inner blanket region 20 of the fuel rod 19, and the upper core fuel region 8A corresponds to the upper core fuel region 13 of each of the fuel rods 10 and 19.

In the inner blanket region 9 of the inner core fuel assembly 7, the fuel rods 10 and 19 are disposed such that the inner blanket region 11 containing the U—Zr metal fuel of the fuel rod 10 and the inner blanket region 20 containing the MA-Zr metal fuel of the fuel rod 19 are mixed (see FIG. 3). In the upper core fuel region 8A of the inner core fuel assembly 7, the upper core fuel region 13 containing the U—Pu—Zr metal fuel of each of the fuel rods 10 and 19 is disposed (see FIG. 2). In the lower core fuel region SB of the inner core fuel assembly 7, the lower core fuel region 12 containing the U—Pu—Zr metal fuel of each of the fuel rods 10 and 19 is disposed.

A height of the core 1 from a lower end thereof to an upper end thereof is, for example, 100 cm. An example of dimensions of the lower core fuel region 5, the inner blanket region 6, and the upper core fuel region 4 in the inner core region 2 will be described. A lower end of the lower core fuel region 5 coincides with the lower end of the core 1, and a length of the lower core fuel region 5 in an axial direction of the core 1 is 40 cm. The inner blanket region 6 is located between a position of 40 cm above the lower end of the core 1 and a position of 60 cm above the lower end of the core 1, and a length of the inner blanket region 6 in the axial direction of the core 1 is 20 cm. The upper core fuel region 4 is located between the position 60 cm above the lower end of the core 1 and the upper end of the core 1, and a length of the upper core fuel region 4 in the axial direction of the core 1 is 40 cm. A middle position of the inner blanket region 6 in the axial direction coincides with, for example, a middle position of the core 1 in the axial direction.

A length, in the axial direction, of a nuclear fuel material-filled region in which the metal fuel is disposed in each of the fuel rods 10 and 19 in the inner core fuel assembly 7, that is, a length in the axial direction from a lower end of an active fuel length to an upper end of the active fuel length is 100 cm, which is the same as the length of the core 1 in the axial direction. In each of the fuel rods 10 and 19, a length of the lower core fuel region 12 in the axial direction is 40 cm, which is the same as that of the lower core fuel region 5. A length of each of the inner blanket regions 11 and 20 in the axial direction is 20 cm, which is the same as that of the inner blanket region 6. A length of the upper core fuel region 13 in the axial direction is 40 cm, which is the same as that of the upper core fuel region 4.

Bond sodium 15, which is liquid metal sodium, is filled in the cladding tube 14 of each of the fuel rods 10 and 19 in the inner core fuel assembly 7. In the fuel rod 10, the bond sodium 15 is filled in a gap formed between each of the U—Pu—Zr metal fuel and the U—Zr metal fuel and an inner surface of the cladding tube 14. In the fuel rod 19, the bond sodium 15 is filled in a gap formed between each of the U—Pu—Zr metal fuel and the MA-Zr metal fuel and the inner surface of the cladding tube 14. In each of the fuel rods 10 and 19, a gas plenum 16 is formed in the cladding tube 14 above a region filled with the bond sodium 15.

In the outer core fuel assembly 21 loaded in the outer core region 3, a plurality of fuel rods 22 are disposed in a wrapper tube 30. A lower end portion of each of the fuel rods 22 is supported by the entrance nozzle (not shown) provided at the lower end of the wrapper tube 30. The cladding tube 14 of the fuel rod 22 is also sealed such that a lower end thereof is closed by the lower end plug 17 and an upper end thereof is closed by the upper end plug. A core fuel region 23 in the cladding tube 14 of the fuel rod 22 is filled with the U—Pu—Zr metal fuel which is a metal fuel material. The inside of the cladding tube 14 of the fuel rod 22 in the outer core fuel assembly 21 is also filled with the bond sodium 15 which is liquid metal sodium. In the fuel rod 22, the bond sodium 15 is also filled in the gap formed between the U—Pu—Zr metal fuel and the inner surface of the cladding tube 14. In the fuel rod 22, the gas plenum 16 is also formed in the cladding tube 14 above the region filled with the bond sodium 15. Plutonium enrichment (=Pu/(Pu+U)) of the core fuel region 23 in the cladding tube 14 of the fuel rod 22 in the outer core fuel assembly 21 at burnup of 0 GWd/t is within a range of 13 wt % to 25 wt %, and is, for example, 25 wt %.

A height of the fuel rod 22 in the outer core fuel assembly 21 from a lower end of an active fuel length to an upper end of the active fuel length is 100 cm, which is the same as the height of the core 1.

A length of a filling region of the metal fuel material in the axial direction in each of the fuel rods 10, 19, and 22, that is, the active fuel length is the same.

As described above, each of the lower core fuel region 5, the inner blanket region 6, and the upper core fuel region 4 in the inner core region 2 is formed by the fuel rods 10 and the fuel rods 19 included in the inner core fuel assembly 7 loaded in the inner core region 2. The plutonium enrichment of each of the lower core fuel region 12 and the upper core fuel region 13 of each of the fuel rods 10 and 19 in the inner core fuel assembly 7 at burnup of 0 GWd/t is also in the range of 13 wt % to 25 wt %, and is, for example, 25 wt %. Further, the U—Zr metal fuel which does not contain MA is disposed in the inner blanket region 11 of the fuel rod 10 in the inner core fuel assembly 7 at burnup of 0 GWd/t, and the MA-Zr metal fuel containing MA is disposed in the inner blanket region 20 of the fuel rod 19 in the fuel assembly 7. Average MA enrichment of the inner blanket region 9 of the inner core fuel assembly 7 is within a range of 3.7 wt % to 12.5 wt %, which will be described later, and is, for example, 8.0 wt %.

Electric power of the fast reactor including the core 1 is, for example, 750,000 kWe, a continuous operation period is 23 months, and average discharge burnup of the core fuel of the fuel assembly loaded in the core 1 is about 100 GWd/t. The discharge of the fuel assembly loaded in the core 1 from the core 1 is executed, for example, in three batches. That is, in each of the fuel assemblies 7 and 21 loaded in the core 1, ⅓ of all the fuel assemblies loaded in the core 1 (⅓ of the fuel assemblies 7 and 21 having experienced the operation in three cycles) is discharged from the core 1 in an operation shutdown period after the operation of the fast reactor in one operation cycle is ended. Then, each of the fuel assemblies 7 and 21 at 0 GWd/t is loaded in the core 1 for replacement.

During operation of the fast reactor, gaseous fission products (FP) generated by nuclear fission of fissile materials (for example, Pu-239) contained in the metal fuel in the fuel rod 10 and the fuel rod 19 are accumulated in the gas plenum 16 present in each fuel rod. The formation of the gas plenum 16 in each fuel rod prevents an increase in pressure in the fuel rod caused by the generation of the gaseous fission product.

As described above, in the inner core fuel assembly 7 at burnup of 0 GWd/t, the fuel rods 10 each including the inner blanket region 11 containing the U—Zr metal fuel which does not contain MA and the fuel rods 19 each including the inner blanket region 20 containing the MA-Zr metal fuel which does not contain U are mixed. Thus, the reason why the fuel rods 10 and the fuel rods 19 are mixed in the inner core fuel assembly 7 is that, when the metal fuel is used, among minor actinides, americium (Am) and curium (Cm) cannot form a homogeneous alloy with uranium (U). By mixing the fuel rods 10 each including the inner blanket region 11 containing the U—Zr metal fuel which does not contain MA and the fuel rods 19 each including the inner blanket region 20 containing the MA-Zr metal fuel in the inner core fuel assembly 7, the inner blanket region 9 containing uranium of the metal fuel and minor actinide of the metal fuel can be easily formed in the inner core fuel assembly 7. By adjusting the number of the fuel rods 10 and the number of the fuel rods 19, it is possible to easily adjust the enrichment of minor actinide in the inner blanket region 9 of the inner core fuel assembly 7 at burnup of 0 GWd/t. Therefore, it is also possible to easily adjust the enrichment of minor actinide in the inner blanket region 6 in the inner core region 2.

The inventors studied a change in the burnup reactivity of the core 1 due to the average enrichment (=MA/(U+MA)) of minor actinide in the inner blanket region 9 of the inner core fuel assembly 7 at burnup of 0 GWd/t. FIG. 7 shows a change in the burnup reactivity of the core 1 due to the average enrichment of minor actinide in the inner blanket region 9, which is obtained by this study. In FIG. 7, the horizontal axis represents the average enrichment (wt %) of minor actinide in the inner blanket region 9 of the inner core fuel assembly 7 at burnup of 0 GWd/t, and the vertical axis represents the burnup reactivity ($) in the inner core fuel assembly 7. Here, minor actinide is Np, Am, and Cm contained in spent nuclear fuel in a spent fuel assembly of a light water reactor at discharge burnup of 60 GWd/t.

As shown in FIG. 7, the burnup reactivity decreases as the average enrichment of minor actinide in the inner blanket region 9 increases, becomes substantially zero when the average enrichment of minor actinide is in the vicinity of 8.0 wt %, and becomes a negative value when the average enrichment of minor actinide further increases. Thus, the reason why the burnup reactivity becomes a negative value is that the reactivity is higher at the end of an equilibrium cycle than at an initial stage of the equilibrium cycle.

As shown in FIG. 7, since the average enrichment of minor actinide in the inner blanket region 9 of the inner core fuel assembly 7 at burnup of 0 GWd/t is the average enrichment of minor actinide within the range of 3.7 wt % to 12.5 wt % (3.7 wt % or more and 12.5 wt % or less), an absolute value of the burnup reactivity becomes 1 $ or less. Further, by setting the average enrichment of minor actinide in the inner blanket region 9 to be within a range of 3.7 wt % to 12.5 wt % (3.7 wt % or more and 12.5 wt % or less), even when assuming an accident (UTOP: Unprotected Transient Over Power) of accidentally withdrawal of the control rod with scram, the increase in the linear heat rate in the fuel assemblies in the vicinity of the control rod is small, the integrity of the fuel rods is maintained, and the safety of the core is improved.

Since the metal fuel containing uranium and the metal fuel containing MA are not homogeneously mixed, a metal fuel containing uranium and MA cannot be produced. In the present embodiment, the inner core fuel assembly 7 includes the plurality of fuel rods 10 each including the inner blanket region 11 in which the metal fuel containing uranium and not containing minor actinide is present, and the plurality of fuel rods 19 each including the inner blanket region 20 in which the metal fuel containing minor actinide and not containing uranium is present. By adjusting the number of the fuel rods 10 and the number of the fuel rods 19, even in the case of the inner core fuel assembly 7 using the metal fuel, it is possible to easily adjust the enrichment of minor actinide in the inner blanket region 9 of the fuel assembly. In addition, since the plurality of inner core fuel assemblies 7 are loaded in the inner core region 2 of the core 1, it is also possible to easily adjust the enrichment of minor actinide in the inner blanket region 6 of the core 1.

Since the metal fuel used in the fuel assembly according to the present embodiment has a higher density than the oxide fuel used in the fuel assembly described in PTL 2, and does not contain oxygen having a neutron scattering effect, the neutron spectrum is hard, and an internal conversion ratio increases. The burnup reactivity of the metal fuel is lower than that of the oxide fuel. As a result, the average MA enrichment of the inner blanket region 9, for reducing the burnup reactivity, of the inner core fuel assembly 7 at burnup of 0 GWdt according to the present embodiment can be made lower than the average MA enrichment of the inner blanket region of the fuel assembly described in PTL 2. In the inner core fuel assembly 7 according to the present embodiment, even when the average MA enrichment of the inner blanket region 9 is reduced, a predetermined burnup reactivity can be obtained.

When the enrichment of MA increases, decay heat of MA increases, and therefore, the difficulty of fuel production (the problem of heat removal at the time of fuel production) increases. According to the present embodiment, since the average MA enrichment of the inner blanket region 9 of the inner core fuel assembly 7 at burnup of 0 GWdt can be made lower than the average MA enrichment of the inner blanket region of the fuel assembly described in PTL 2, the productivity of the fuel used in the present embodiment is improved.

### Second Embodiment

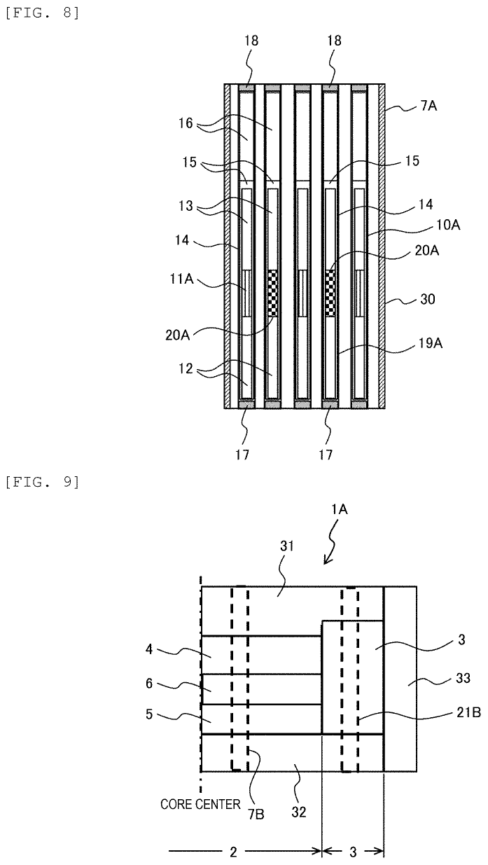

A core of a fast reactor according to a second embodiment, which is another preferred embodiment of the invention, will be described with reference to FIG. 8

In the core of the fast reactor according to the present embodiment, an inner core fuel assembly 7A shown in FIG. 8 is used instead of the inner core fuel assembly 7 used in the first embodiment. The configuration other than the inner core fuel assembly 7A in the core of the fast reactor according to the present embodiment is the same as the configuration of the core 1 of the fast reactor according to the first embodiment. The inner core fuel assembly 7A is loaded in the inner core region 2 of the core 1 according to the present embodiment.

The inner core fuel assembly 7A includes a plurality of fuel rods 10A and a plurality of fuel rods 19A. The configuration of the inner core fuel assembly 7A other than the fuel rods 10A and 19A is the same as the configuration of the inner core fuel assembly 7 used in the first embodiment. As well in the fuel rods 10A and 19A, the lower end and the upper end of the cladding tube 14 are sealed by the lower end plug 17 and the upper end plug 18, respectively.

In the fuel rod 10A, a U—Pu—Zr metal fuel and a U—Zr metal fuel are used as metal fuel materials. In the fuel rod 10A, the lower core fuel region 12 and the upper core fuel region 13 are formed in the cladding tube 14 in the same manner as in the fuel rod 10, and an inner blanket region 11A is formed between the lower core fuel region 12 and the upper core fuel region 13. The U—Pu—Zr metal fuel is disposed in the lower core fuel region 12 and the upper core fuel region 13, and the U—Zr metal fuel is disposed in the inner blanket region 11A.

In the fuel rod 19A, the U—Pu—Zr metal fuel and the MA-Pu—Zr metal fuel are used as the metal fuel materials. In the fuel rod 19A, the lower core fuel region 12 and the upper core fuel region 13 are formed in the cladding tube 14 in the same manner as in the fuel rod 10, and an inner blanket region 20A is formed between the lower core fuel region 12 and the upper core fuel region 13. The U—Pu—Zr metal fuel is disposed in the lower core fuel region 12 and the upper core fuel region 13, and a MA-Pu—Zr metal fuel is disposed in the inner blanket region 20A.

The above U—Pu—Zr metal fuel and MA-Pu—Zr metal fuel in the present embodiment also have a solid columnar shape.

Plutonium enrichment in the inner blanket regions 11A and 20A of the fuel rods of the inner core fuel assembly 7A at burnup of 0 GWdt may be set to plutonium enrichment within a range of more than 0 wt % and 13 wt % or less, for example, 10 wt %. By setting the plutonium enrichment within this range, a temporal variation and a spatial distribution of the power distribution in the core of the fast reactor according to the present embodiment can be flattened as much as possible, and a target core reactivity can be implemented.

In the present embodiment, average enrichment of minor actinide in the inner blanket region 9 of the inner core fuel assembly 7A at burnup of 0 GWdt is average enrichment of minor actinide within the range of 3.7 wt % to 12.5 wt % (3.7 wt % or more and 12.5 wt % or less).

Table 1 shows configurations of the inner blanket region of each of the fuel rods 10A and 19A used in the inner core fuel assembly 7A in the present embodiment. Here, in the inner core fuel assembly 7A, the number of the fuel rods 10A is N52, and the number of the fuel rods 19A is N54.

TABLE 1
Configuration of Inner Blanket Region of Inner Core Fuel
Assembly Used in Second Embodiment

| Reference | | Inner | Pu | |
|---|---|---|---|---|
| sign of | | blanket | enrichment | |
| fuel rod | Number | fuel | (wt %) | Note |
| 10A | N52 | U-Zr | [Pu/(U + Pu)] × | — |
| | | alloy | 100 < 13 | |
| 19A | N54 | MA-Pu-Zr | [Pu/(MA + Pu)] × | 3.7 ≤ N54 × |
| | | alloy | 100 < 13 | 100/(N54 + |
| | | | | N52) ≤ 12.5 |

“3.7≤N54×100/(N54+N52)≤12.5” in Table 1 is a condition that the average MA enrichment of the inner blanket region 9 of the inner core fuel assembly 7A is within the range of 3.7 wt % to 12.5 wt %.

In the present embodiment, the effects generated in the first embodiment can be exerted.

### Third Embodiment

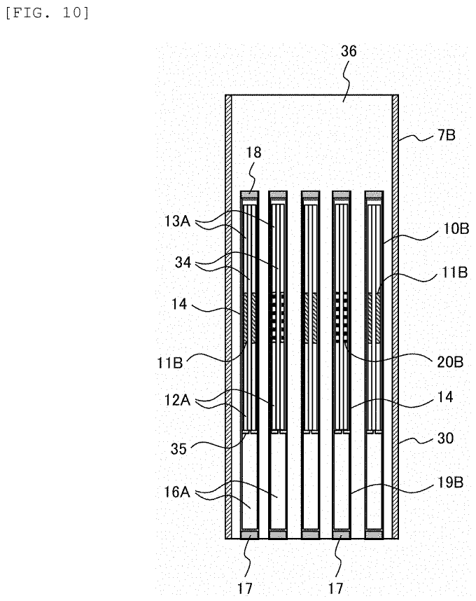

A core of a fast reactor according to a third embodiment, which is another preferred embodiment of the invention, will be described with reference to FIGS. 9, 10, and 11.

As shown in FIG. 9, in a core 1A of a fast reactor according to the present embodiment, the inner core region 2 is disposed at a center of the core 1A, and the core 1A further includes the outer core region 3 surrounding the inner core region 2, and a radial blanket region 33 surrounding the outer core region 3. The lower ends of the inner core region 2 and the outer core region 3 are present at the same position in the axial direction of the core 1A. Although not shown in FIG. 9, the reflector region 26 described in the first embodiment surrounds the radial blanket region 33. A height of the outer core region 3 is higher than a height of the inner core region 2, and in the axial direction of the core 1A, the upper end of the outer core region 3 is located above the upper end of the inner core region 2. The lower ends of the outer core region 3 and the inner core region 2 are present at the same position in the axial direction of the core 1A.

In the inner core region 2, the lower core fuel region 5, the inner blanket region 6, and the upper core fuel region 4 are formed in an upward direction. Further, the core 1A includes a gas plenum region 32 formed below the lower core fuel region 5 and the outer core region 3, and a sodium plenum region 31 formed above the upper core fuel region 4 and the outer core region 3. The lower ends of the lower core fuel region 5 and the outer core region 3 are located at an upper end of the gas plenum region 32.

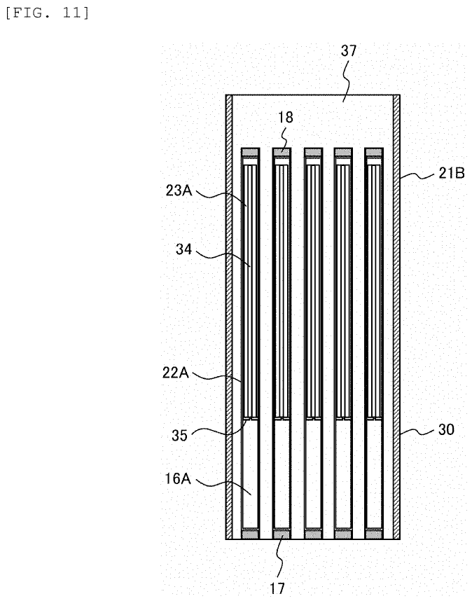

A plurality of inner core fuel assemblies 7B are loaded in the inner core region 2, and a plurality of outer core fuel assemblies 21B are loaded in the outer core region 3. As shown in FIG. 10, each of the inner core fuel assemblies 7B includes a plurality of fuel rods 10B and a plurality of fuel rods 19B that are disposed in the wrapper tube 30 made of stainless steel. A metal fuel, which is a nuclear fuel material, is disposed in the cladding tube 14 of each of the fuel rods 10B and 19B, and the lower end and the upper end of cladding tube 14 are sealed. The metal fuel is held by a support element 35 provided in the cladding tube 14, and is disposed above the support element 35. A gas plenum 16A is formed in the cladding tube 14 below the support element 35.

In the fuel rod 10B, a lower core fuel region 12A, an inner blanket region 11B, and an upper core fuel region 13A are formed upward from the support element 35 in a nuclear fuel material-filled region which is located above the support element 35 in the cladding tube 14 and in which the metal fuel is disposed. The U—Pu—Zr metal fuel is disposed in each of the lower core fuel region 12 and the upper core fuel region 13. The inner blanket region 11B contains the U—Zr metal fuel. A shape of the U—Pu—Zr metal fuel disposed in each of the lower core fuel region 12A and the upper core fuel region 13A is a cylinder having a hole 34. The U—Zr metal fuel disposed in the inner blanket region 11B is also a cylinder having the hole 34. A hole penetrating a center portion of the support element 35 is also formed in the support element 35 provided in the fuel rod 10B. In the fuel rod 10B, this hole establishes communication between the gas plenum 16A and the hole 34 formed in the metal fuel.

In the fuel rod 19B, the lower core fuel region 12A, an inner blanket region 20B, and the upper core fuel region 13A are formed upward from the support element 35 in a nuclear fuel material-filled region which is located above the support element 35 in the cladding tube 14 and in which the metal fuel is disposed. The U—Pu—Zr metal fuel is disposed in each of the lower core fuel region 12 and the upper core fuel region 13. The MA-Zr metal fuel is disposed in the inner blanket region 20B. A shape of the U—Pu—Zr metal fuel disposed in each of the lower core fuel region 12A and the upper core fuel region 13A is a cylinder having a hole 34. A shape of the MA-Zr metal fuel disposed in the inner blanket region 20B is also a cylinder having the hole 34. A hole penetrating a center portion of the support element 35 is also formed in the support element 35 provided in the fuel rod 19B. In the fuel rod 19B, this hole establishes communication between the gas plenum 16A and the hole 34 formed in the metal fuel.

The U—Pu—Zr metal fuel, the U—Zr metal fuel, and the MA-Zr metal fuel in the present embodiment are hollow metal fuels.

Plutonium enrichment of each of the lower core fuel region 12A and the upper core fuel region 13A in each of the fuel rods 10B and 19B in the inner core fuel assembly 7B at burnup of 0 GWd/t is the same as the plutonium enrichment of each of the lower core fuel region 12 and the upper core fuel region 13 of each of the fuel rods 10 and 19 in the first embodiment, and is, for example, 25 wt %. Average minor actinide enrichment of the inner blanket region 9 in the inner core fuel assembly 7B at burnup of 0 GWd/t and formed by the inner blanket region 11B of the fuel rod 10B and the inner blanket region 20B of the fuel rod 19B is within the range of 3.7 wt % to 12.5 wt % (3.7 wt % or more and 12.5 wt % or less), and is, for example, 8.0 wt %.

In the outer core fuel assembly 21B, a plurality of fuel rods 22A each having a wire spacer (not shown) wound around an outer surface thereof are disposed in the wrapper tube 30. In the fuel rod 22A, a core fuel region 23A in the cladding tube 14 whose both ends are sealed is filled with the U—Pu—Zr metal fuel which is a metal fuel material. A shape of the U—Pu—Zr metal fuel is a cylinder having the hole 34. The metal fuel is held by the support element 35 provided in the cladding tube 14 of the fuel rod 22A, and is disposed above the support element 35. The gas plenum 16A is formed in the cladding tube 14 below the support element 35. In the fuel rod 22A, a hole formed in the support element 35 establishes communication between the gas plenum 16A and the hole 34 in the U—Pu—Zr metal fuel.

In the wrapper tube 30 of the inner core fuel assembly 7B, a sodium plenum region 36 is formed above the upper ends of the fuel rods 10B and 19B. In addition, in the wrapper tube 30 of the outer core fuel assembly 21B, a sodium plenum region 37 is formed above the upper ends of the fuel rods 22A. The sodium plenum region 31 of the core 1A is formed by the sodium plenum regions 36 and 37.

The lower end of the inner core region 2 is present at the same position as the lower end of the outer core region 3 in the axial direction of the core 1A (see FIG. 9). Therefore, a lower end of an active fuel length of the fuel rods 10B and 19B in the inner core fuel assembly 7B loaded in the core 1A (see FIG. 10) and a lower end of an active fuel length of the fuel rod 22A in the outer core fuel assembly 21B (see FIG. 11) are present at the same position in the axial direction of the core 1A. The active fuel length of the fuel rod 22A is longer than the active fuel length of the fuel rods 10B and 19B, and an upper end of the active fuel length of the fuel rod 22A is located above an upper end of the active fuel length of the fuel rods 10B and 19B. Therefore, a length of the sodium plenum region 37 in the outer core fuel assembly 21B in the axial direction of the core 1A is shorter than a length of the sodium plenum region 36 in the inner core fuel assembly 7B.

An example of dimensions of the lower core fuel region 5, the inner blanket region 6, and the upper core fuel region 4 in the inner core region 2 of the core 1A according to the present embodiment will be described. The lower end of the lower core fuel region 5 is the lower end of the inner core region 2 and coincides with the upper end of the gas plenum region 32. The lengths of the lower core fuel region 5, the inner blanket region 6, and the upper core fuel region 4 in the inner core region 2 of the core 1A in the axial direction of the core 1A are the same as the lengths of the lower core fuel region 5, the inner blanket region 6, and the upper core fuel region 4 in the inner core region 2 of the core 1 according to the first embodiment, respectively. The length of the lower core fuel region 5 in the axial direction of the core 1A is 40 cm. The inner blanket region 6 is located between a position 40 cm above the lower end of the inner core region 2 and a position 60 cm above the lower end of the inner core region 2, and the length of the inner blanket region 6 in the axial direction of the core 1A is 20 cm. The upper core fuel region 4 is located between the position 60 cm above the lower end of the inner core region 2 and the upper end of the inner core region 2, and the length of the upper core fuel region 4 in the axial direction of the core 1A is 40 cm. A middle position of the inner blanket region 6 in the axial direction coincides with, for example, a middle position of the inner core region 2 in the axial direction.

The inventors studied the position of the inner blanket region 6 in the inner core region 2 of the core 1A, in particular, the position of the inner blanket region 6 in the axial direction of the inner core region 2. As a result of the study, the inventors newly found the following matters.

In the study, the inventors investigated changes in the burnup reactivity and the void reactivity of the core 1A by shifting the middle position of the inner blanket region 6 in the axial direction from the middle position of the inner core region 2 in the axial direction, that is, a reference position. Even when the middle position of the inner blanket region 6 in the axial direction was vertically shifted by 5 cm from the reference position, the burnup reactivity did not change. However, by shifting the middle position of the inner blanket region 6 in the axial direction downward by 5 cm from the reference position, the void reactivity became a more negative value. Therefore, it is desirable that the middle position of the inner blanket region 6 in the axial direction is located in a range between the reference position and a position shifted downward by 5 cm from the reference position. The value of the void reactivity becomes more negative as the middle position of the inner blanket region 6 in the axial direction is disposed below the reference position in the range. When the middle position of the inner blanket region 6 is disposed at the position shifted downward by 5 cm from the reference position, an absolute value of the negative value of the void reactivity becomes the largest.

Thus, by shifting the middle position of the inner blanket region 6 downward, reactor power in the upper core fuel region 4 of the inner core region 2 increases, neutrons leaking from the upper core fuel region 4 to the sodium plenum region 31 positioned above the upper core fuel region 4 increase, and the void reactivity of the core 1A becomes more negative.

The present embodiment can exert the effects obtained in the first embodiment. Further, in the present embodiment, since the length of the inner core region 2 in the axial direction of the core 1A is shorter than that of the outer core region 3, the void reactivity of the core 1A can be reduced. Since the metal fuel disposed in the fuel rods 10B and 19B in the inner core fuel assembly 7B and the fuel rods 22A in the outer core fuel assembly 21B that are loaded in the core 1A according to the present embodiment has a cylindrical shape and the holes 34 are formed, a smear density of the metal fuel is 75%, and it is possible to absorb swelling of the metal fuel accompanying the burnup of the fissile material contained in the metal fuel. Therefore, it is not necessary to fill the inside of the fuel rods 10B and 19B in the inner core fuel assembly 7B and the fuel rod 22A in the outer core fuel assembly 21B with the bond sodium 15 similarly to the fuel rods 10 and 19 in the inner core fuel assembly 7 and the fuel rod 22 in the outer core fuel assembly 21 used in the first embodiment.

In the present embodiment, when an inventory of the nuclear fuel material in the inner core region 2 is the same as that in the outer core region 3, by making the length of the inner core region 2 in the axial direction of the core 1A having a large contribution of the void reactivity shorter than that of the outer core region 3, the void reactivity of the core 1A can be reduced as compared with a case where the length of the inner core region 2 in the axial direction of the core 1A is the same as that of the outer core region 3.

### Fourth Embodiment

A core of a fast reactor according to a fourth embodiment, which is another preferred embodiment of the invention, will be described with reference to FIGS. 1, 12, and 13.

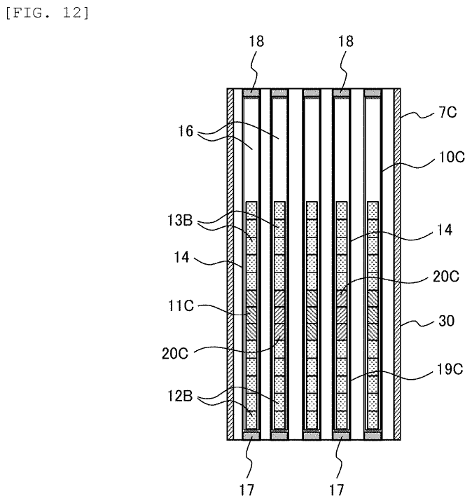

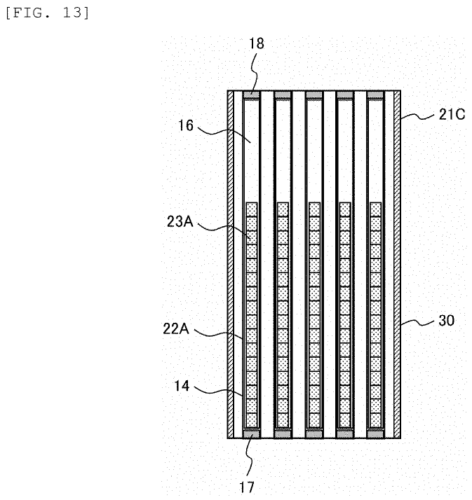

The core of the fast reactor according to the present embodiment has a configuration in which, in the core 1 according to the first embodiment, the inner core fuel assembly 7 loaded in the inner core region 2 is replaced with an inner core fuel assembly 7C shown in FIG. 12, and the outer core fuel assembly 21 loaded in the outer core region 3 is replaced with an outer core fuel assembly 21C shown in FIG. 13. In the inner core fuel assembly 7C and the outer core fuel assembly 21C, an oxide fuel is used as the nuclear fuel material instead of the metal fuel. Other configurations of the core of the fast reactor according to the present embodiment are the same as the other configurations of the core 1 according to the first embodiment.

A lower core fuel region 12B and an upper core fuel region 13B in the sealed cladding tube 14 of each of a plurality of fuel rods 10C and 19C in the inner core fuel assembly 7C at burnup of 0 GWdt which is loaded in the inner core region 2 of the core according to the present embodiment, are filled with a plurality of fuel pellets made of a mixed oxide fuel (a MOX fuel) of depleted uranium oxide and plutonium oxide. An inner blanket region 11C in the sealed cladding tube 14 of the fuel rod 100 is filled with a plurality of fuel pellets made of an oxide fuel of depleted uranium which does not contain minor actinide. The inner blanket region 20C in the sealed cladding tube 14 of the fuel rod 19C is filled with a plurality of fuel pellets made of an oxide fuel containing minor actinide and depleted uranium.

The core fuel region 23A in the sealed cladding tube 14 of each of the plurality of fuel rods 22A in the outer core fuel assembly 21C at burnup of 0 GWdt which is loaded in the outer core region 3 of the core according to the present embodiment, is filled with a plurality of fuel pellets made of a mixed oxide fuel (a MOX fuel) of depleted uranium oxide and plutonium oxide. Plutonium enrichment in the core fuel region 23A has the same value as the plutonium enrichment of the core fuel region 23 of the fuel rod 22 in the first embodiment.

The fuel pellets filled in the fuel rods 10C, 19C, and 22A are solid fuel pellets.

In the inner core fuel assembly 7C in the present embodiment, the fuel rods 10C each including an inner blanket region 11C containing an oxide fuel of depleted uranium which does not contain minor actinide and fuel rods 19C each including an inner blanket region 20C containing an oxide fuel of minor actinide and depleted uranium are mixed. Therefore, according to the present embodiment, by adjusting the number of the fuel rods 10C and the number of the fuel rods 19C, even in the inner core fuel assembly 7C using the oxide fuel, the enrichment of minor actinide in the inner blanket region 9 of the inner core fuel assembly 7C at burnup of 0 GWdt can be easily adjusted. In addition, since the plurality of inner core fuel assemblies 7C are loaded in the inner core region 2 of the core according to the present embodiment, the enrichment of minor actinide in the inner blanket region 6 of the core can be easily adjusted.

### Fifth Embodiment

A core of a fast reactor according to a fifth embodiment, which is another preferred embodiment of the invention, will be described with reference to FIGS. 1, 12, and 13.

The core of the fast reactor according to the present embodiment has a configuration in which, in the core of the fast reactor according to the second embodiment, the fuel rods 10A and 19A containing the metal fuel of the inner core fuel assembly 7A loaded in the inner core region 2 are replaced with the fuel rods 10C and 19C, containing the oxide fuel, of the inner core fuel assembly 7C used in the fourth embodiment, and further, the fuel rod 22, containing the metal fuel, of the outer core fuel assembly 21 loaded in the outer core region 3 is replaced with the fuel rod 22A, containing the oxide fuel, of the outer core fuel assembly 21C used in the fourth embodiment.

The configuration of the outer core fuel assembly 210 loaded in the core of the fast reactor according to the present embodiment is the same as the configuration of the outer core fuel assembly 21C used in the fourth embodiment. In the inner core fuel assembly 7C loaded in the core, the inner blanket region 110 of the fuel rod 100 and the inner blanket region 20C of the fuel rod 19C contain plutonium similarly to the inner core fuel assembly 7A. That is, the inner blanket region 11C of the fuel rod 10C is filled with a plurality of fuel pellets made of an oxide fuel which contains depleted uranium and plutonium and does not contain minor actinide. The inner blanket region 20C of the fuel rod 19C is filled with a plurality of fuel pellets made of an oxide fuel containing depleted uranium, plutonium, and minor actinide.

According to the present embodiment, the effects obtained in the second embodiment can be exerted by such a core structure.

### REFERENCE SIGN LIST

1, 1A core
2 inner core region
3 outer core region
4, 8A, 13A upper core fuel region
5, 8B, 12, 12A lower core fuel region
6, 9, 11, 11A, 11B, 20, 20A, 20B inner blanket region
7, 7A, 7B inner core fuel assembly
10, 10A, 10B, 19, 19A, 19B, 22, 22A fuel rod
16, 16A gas plenum
21, 21B outer core fuel assembly
23, 23A core fuel region
31, 36, 37 sodium plenum region
32 gas plenum region

1. A fuel assembly in which a nuclear fuel material region in which a nuclear fuel material is present is formed, and a first lower core fuel region, a first inner blanket region, and a first upper core fuel region are formed in the nuclear fuel material region in this order from a lower end to an upper end of the nuclear fuel material region, the fuel assembly comprising:
a plurality of first fuel rods in which the nuclear fuel material is present; and
a plurality of second fuel rods in which the nuclear fuel material is present, wherein
in each of the first fuel rods, a second lower core fuel region is formed at a position corresponding to the first lower core fuel region, a second inner blanket region is formed at a position corresponding to the first inner blanket region, and a second upper core fuel region is formed at a position corresponding to the first upper core fuel region,
in each of the second fuel rods, a third lower core fuel region is formed at a position corresponding to the first lower core fuel region, a third inner blanket region is formed at a position corresponding to the first inner blanket region, and a third upper core fuel region is formed at a position corresponding to the first upper core fuel region, and
the nuclear fuel material present in the second inner blanket region of the first fuel rod does not contain minor actinide and contains uranium, and the nuclear fuel material present in the third inner blanket region of the second fuel rod does not contain uranium and contains minor actinide.

2. The fuel assembly according to claim 1, wherein
the nuclear fuel material present in the third inner blanket region of the second fuel rod contains plutonium in addition to minor actinide.

3. The fuel assembly according to claim 2, wherein
the nuclear fuel material having a solid shape is disposed in a sealed cladding tube of each of the first fuel rods and the second fuel rods, and bond sodium is filled between the nuclear fuel material and the cladding tube.

4. The fuel assembly according to claim 3, wherein
the nuclear fuel material is a metal fuel.

5. The fuel assembly according to claim 4, wherein
the nuclear fuel material having a hollow shape is disposed in a sealed cladding tube of each of the first fuel rods and the second fuel rods.

6. The fuel assembly according to claim 5, wherein
average enrichment of minor actinide in the first inner blanket region is within a range of 3.7 wt % or more and 12.5 wt % or less.

7. The fuel assembly according to claim 6, wherein
plutonium enrichment of the nuclear fuel material present in the third inner blanket region is within a range of more than 0 wt % and 13 wt % or less.

8. The fuel assembly according to claim 3, wherein
the nuclear fuel material is an oxide fuel.

9. The fuel assembly according to claim 4, wherein
the first fuel rods and the second fuel rods are disposed in a manner of mixing in each other in a cross section of the fuel assembly.

10. The fuel assembly according to claim 8, wherein
the first fuel rods and the second fuel rods are disposed in a manner of mixing in each other in a cross section of the fuel assembly.

11. A core of a fast reactor, the core comprising:
an inner core region in which a plurality of first fuel assemblies are loaded; and
an outer core region which surrounds the inner core region and in which a plurality of second fuel assemblies are loaded, wherein
a fourth lower core fuel region, a fourth inner blanket region, and a fourth upper core fuel region are formed in the inner core region in this order from a lower end to an upper end of the inner core region,
the first fuel assembly is the fuel assembly according to claim 1, and
the fourth lower core fuel region is formed at a position corresponding to the second lower core fuel region, the fourth inner blanket region is formed at a position corresponding to the second inner blanket region, and the fourth upper core fuel region is formed at a position corresponding to the second upper core fuel region.

12. A core of a fast reactor, the core comprising:
an inner core region in which a plurality of first fuel assemblies are loaded; and
an outer core region which surrounds the inner core region and in which a plurality of second fuel assemblies are loaded, wherein
a fourth lower core fuel region, a fourth inner blanket region, and a fourth upper core fuel region are formed in the inner core region in this order from a lower end to an upper end of the inner core region,
the first fuel assembly is the fuel assembly according to claim 4, and
the fourth lower core fuel region is formed at a position corresponding to the second lower core fuel region, the fourth inner blanket region is formed at a position corresponding to the second inner blanket region, and the fourth upper core fuel region is formed at a position corresponding to the second upper core fuel region.

13. A core of a fast reactor, the core comprising:
an inner core region in which a plurality of first fuel assemblies are loaded; and
an outer core region which surrounds the inner core region and in which a plurality of second fuel assemblies are loaded, wherein
a fourth lower core fuel region, a fourth inner blanket region, and a fourth upper core fuel region are formed in the inner core region in this order from a lower end to an upper end of the inner core region,
the first fuel assembly is the fuel assembly according to claim 8, and
the fourth lower core fuel region is formed at a position corresponding to the second lower core fuel region, the fourth inner blanket region is formed at a position corresponding to the second inner blanket region, and the fourth upper core fuel region is formed at a position corresponding to the second upper core fuel region.

14. The core of the fast reactor according to claim 11, wherein
a position of the upper end of the inner core region is lower than a position of an upper end of the outer core region.

15. The core of the fast reactor according to claim 13, wherein
a position of the upper end of the inner core region is lower than a position of an upper end of the outer core region.

16. The core of the fast reactor according to claim 12, wherein
a middle position of the fourth inner blanket region in an axial direction is within a range between a middle position of the inner core region in the axial direction and a position shifted downward by 5 cm from the middle position of the inner core region in the axial direction.

17. The core of the fast reactor according to claim 15, wherein
a middle position of the fourth inner blanket region in an axial direction is within a range between a middle position of the inner core region in the axial direction and a position shifted downward by 5 cm from the middle position of the inner core region in the axial direction.
